(19) United States
(12) Patent Application Publication
(10) Pub. No.: US 2008/0255756 A1
(43) Pub. Date: Oct. 16, 2008

(54) Navigation Method

(76) Inventors: Arne Friedrichs, Braunschweig (DE); Gerd Draeger, Braunschweig (DE); Michael Laedke, Hildesheim (DE)

Correspondence Address: KENYON & KENYON LLP, ONE BROADWAY, NEW YORK, NY, 10004, US

(21) Appl. No.: 11/659,905

(22) PCT Filed: Jun. 16, 2005
(86) PCT No.: PCT/EP2005/052792

§ 371 Date: Feb. 22, 2008

(30) Foreign Application Priority Data
Aug. 14, 2004 (DE) 10 2004 039 465.2

(51) Int. Cl. G01C 21/34

(52) U.S. Cl. 701/201

(57) ABSTRACT

A method for navigating from a starting location to a destination location includes calculating a total route that is divided into at least two partial routes, at least one partial route being calculated locally in a mobile navigation client and at least one other partial route being calculated centrally in a stationary route server. At least one transfer point is ascertained as the end point of a first partial route and as the starting point of a second partial route as a function of the resulting total route.

### BACKGROUND OF THE INVENTION

1. Field of the Invention

The present invention relates to a method for navigating from a starting location to a destination location in which an overall route is calculated, divided into at least two partial routes, at least one partial route being calculated locally in a mobile navigation client and at least one other partial route being calculated centrally in a stationary route server.

2. Description of Related Art

Navigation systems have become very popular in recent years. Autarchic navigation systems in particular, which operate independently and perform the route calculation themselves, are currently in widespread use. These navigation systems are used in the transportation means to be navigated, e.g., in the motor vehicle, aircraft or ship, and are thus mobile.

Furthermore, there are known navigation systems in which a stationary central unit having a server calculates the route. The transportation means to be navigated communicates with the central unit here, e.g., via a mobile wireless connection or the like. The current position data and the destination specifications are sent from the transportation means to the central unit, which then calculates the route and transmits the fully calculated route to the transportation means.

In addition, a combination of these two methods, known as hybrid navigation, has also become known. In hybrid navigation, on request by decentralized navigation clients, a route calculation is performed by the stationary route server, and the route thus calculated is transmitted to the particular navigation client. However, the navigation clients are also capable of independent route calculation.

For example, published European patent document EP 1 141 910 describes a navigation method in which either an internal navigation algorithm of a navigation system performs a navigation with reference to an internally calculated route component or an external navigation algorithm performs a navigation by using an externally calculated route component.

However, in the case of such a hybrid method, i.e., a combination of internal and external route calculation, there is the essential disadvantage that a new route to be calculated must be broken down into two partial sections, i.e., partial routes which are calculated completely independently of one another. The total route which is then assembled usually does not constitute the optimum route which is actually being sought, because the partial routes have been calculated by using different databases, each of which is incomplete.

### A BRIEF SUMMARY OF THE INVENTION

An object of the present invention is to improve upon the conventional navigation method.

The present invention provides ascertaining at least one transfer point as the end point of a first partial route and the starting point of a second partial route as a function of the resulting total route.

The navigation system that determines the transfer point, either the mobile navigation client or the stationary route server, will ascertain the transfer point by using not just its own particular database, but instead by using the two systems in the totality of available information. By accessing both systems, which communicate with one another for the route calculation, it is possible to calculate an optimum route with regard to travel time and/or travel distance, which route is an improvement in comparison to the route calculated according to known hybrid navigation methods.

An exemplary implementation of the method according to the present invention has the following steps:
recognizing that the total route to the destination is not locally calculable;
transmitting the destination location from the mobile navigation client to a stationary route server;
transmitting a destination list to the mobile navigation client;
confirming a destination by the user in the navigation client;
ascertaining at least one transfer point;
transmitting the transfer point to the route server;
calculating the particular partial route from the selected transfer point to the destination location in the stationary route server; and
transmitting the particular calculated partial route to the mobile navigation client.

According to an exemplary implementation of the method according to the present invention, the point on the locally calculable partial route that is the shortest geographic distance from the destination location is selected as the transfer point. The selection may be made from the stationary route server, which generally has access to more complete map material. However, it is likewise possible for the mobile navigation client to determine the transfer point after the stationary route server has transmitted the coordinates of the selected destination.

In an alternative exemplary implementation of the method according to the present invention, a point is selected on the locally calculable partial route such that this point is located between the starting point and the point on the partial route which is the shortest geographic distance from the destination location. In general, the calculated route will not correspond to the straight-line distance, so a transfer point ascertained in this way may result in a total route having a shorter travel distance.

Another exemplary implementation of the method according to the present invention has the following steps:
preselecting multiple points on the locally calculable partial route situated between the starting point and the point on the partial route which is the shortest geographic distance from the destination location;
calculating the particular partial routes and calculating the travel distance and travel time for each partial route; and
of those preselected points, selecting as the transfer point the point at which the total route composed of the partial routes yields the optimum total route, taking into account the travel distance and/or travel time.

Another exemplary implementation of the method according to the present invention includes the following steps:
preselecting several locally calculable points which are at a predetermined maximum geographic distance from the destination location;
calculating the particular partial routes and calculating the travel distance and travel time for each partial route; and
of those preselected points, selecting as the transfer point the point at which the total route composed of the partial routes yields the optimum total route, taking into account the travel distance and/or travel time.

The optimum total route takes into account the route options set by the user (e.g., 100% fast+0% short to 0% fast+100% short).

In the preselection, this example implementation draws an imaginary radius around the specified destination and takes into account all possible transfer points within the circle thereby formed. This fails to take into account whether the possible transfer point would be situated on or near a route calculated by a mobile client in a traditional hybrid navigation system. Thus a total route, which would seemingly be a detour but represents the best alternative because of the roads to be traveled on and/or the prevailing traffic situation to be taken into account, may also be calculated.

According to an example implementation, the preselected points are at existing intersections and/or turnoff points. This limits the preselection somewhat but it reduces the computation complexity and thus results in a more rapid result.

As an alternative, it is possible to provide for the preselected points to be situated at existing intersections and/or turnoff points or approximately at the center between these intersections.

### BRIEF DESCRIPTION OF THE SEVERAL VIEWS OF THE DRAWINGS

FIG. 1a shows a map for illustrating a first example of a method according to the present invention for determining the transfer point.

FIG. 1b shows the map from FIG. 1a, additionally showing the partial route calculated by the stationary route server.

FIG. 2 shows a map for illustrating a second example of a method according to the present invention for determining the transfer point.

FIG. 3a shows a map for illustrating a third example of a method according to the present invention having a plurality of selected points.

FIG. 3b shows the map from FIG. 3a, additionally showing the particular calculated partial routes.

FIG. 4a shows a map for illustrating a fourth example of a method according to the present invention having a plurality of selected points;

FIG. 4b shows the map from FIG. 4a, additionally showing the particular recalculated partial routes.

### DETAILED DESCRIPTION OF THE INVENTION

A mobile navigation client has a digitized map having restricted territorial coverage or restricted map accuracy and an algorithm for route calculation. Furthermore, this system may establish a communications link with a central route server. The route server has extensive map data, ideally with 100% coverage, having a high resolution, and is frequently updated. Finally, the route server also has an algorithm for calculating a route.

When the user, who is travelling in a transportation means having the mobile navigation client installed there, desires a destination that is not present in the map data of the mobile navigation client, this destination is queried from a central route server via a mobile wireless connection. If the route server knows this destination on the basis of the database available to it, it sends this information to the mobile navigation client. For example, after confirmation of a destination, the mobile navigation client transmits the preselected destination in a text display, based on the destination described in text by the route server and transmitted to the navigation client, and the stationary route planner sends back the coordinates.

The total route between the starting location and the destination location is divided into at least two partial routes, the first part to the transfer point being calculated by the mobile navigation client, and the second part from the transfer point being calculated by the central route server. The second part of the total route is transmitted to the mobile navigation client over the mobile wireless link mentioned above. From the starting location to the transfer point, the user is guided along the first partial route calculated by the mobile navigation client. At the transfer point the mobile navigation client switches to the second partial route calculated by the central route server.

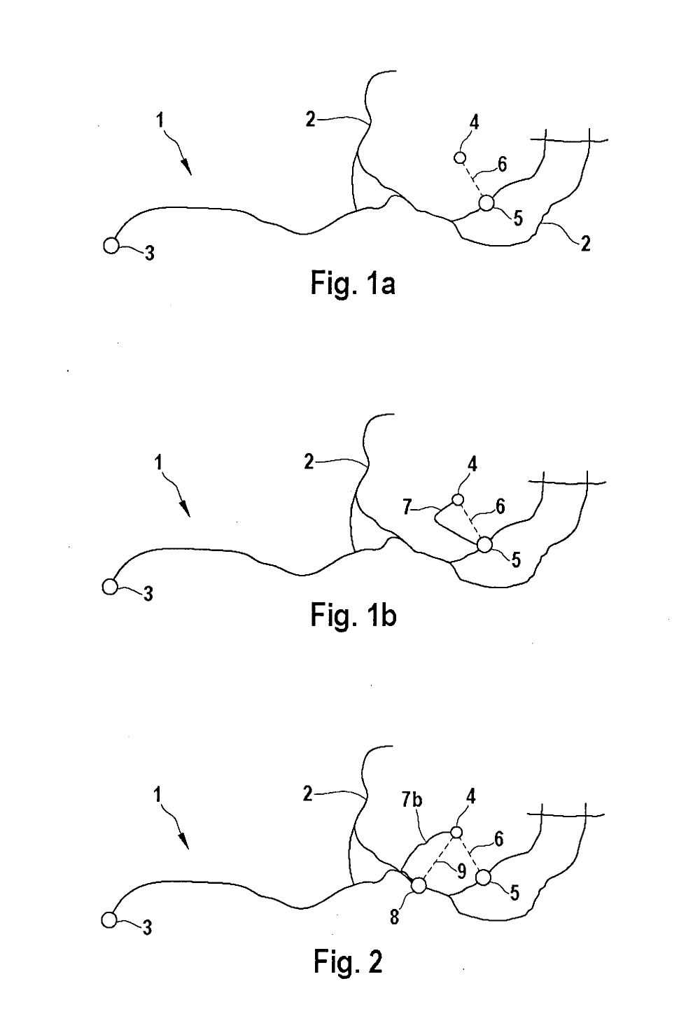

Suitable determination of the transfer point is essential for efficient execution of the navigation method according to the present invention. A first example of determining the transfer point is illustrated in FIGS. 1a and b. FIG. 1a shows a map detail 1 showing various roads 2, starting location 3 and destination location 4 for the route calculation. Although starting location 3 is on a road which is known to the mobile navigation client, destination location 4 is outside of the map data available to the mobile navigation client.

Based on the communication between the mobile communication system and the central route server, the mobile navigation client knows the coordinates of the destination location but is unable to calculate a complete drivable route. On the basis of the known coordinates of destination location 4, the mobile navigation client determines a point 5 in the map data available to it, and specifies this point 5 as the transfer point. In this example, the determination is based on the condition that the straight-line distance indicated by dashed line 6 between transfer point 5 and destination location 4 is the shortest straight-line distance between destination location 4 and all points in the map data available to the mobile navigation client.

After transfer point 5 has been determined by the mobile navigation client, this point 5 is reported to the central route server via the mobile wireless connection. The central route server then calculates a partial route between transfer point 5 and destination location 4. This partial route 7 is shown in FIG. 1b. Although this method is easy to implement because only the map data of the mobile navigation client is accessed to determine the transfer point, it may, however, happen that the user takes a detour because the path of partial route 7 does not usually correspond to the straight-line distance as shown in FIG. 1b.

FIG. 2 illustrates another example of determination of the transfer point. Again, FIG. 2 shows map detail 1 having road layout 2 known from FIG. 1. Starting location 3 and destination location 4 are also identical. Instead of determining a point 5, representing the shortest straight-line distance 6 from destination location 4, as the transfer location, point 8 which is on the route between starting location 3 and point 5 is determined as the transfer point. Although transfer point 8 is at a greater straight-line distance 9 from destination location 4, the total travel distance may be shorter.

Boundary conditions are to be defined to prevent starting point 3 from being selected as the transfer point because the shortest distance between starting location 3 and destination location 4 is the direct straight-line distance. Possible boundary conditions include for example the fact that straight-line distance 9 must not be any greater than two or three times the shortest straight-line distance 6. Another boundary condition may be that the travel distance of the partial route between starting location 3 and transfer point 8 must be no greater than half the travel distance of the partial route between starting location 3 and transfer point 5. As FIG. 2 shows, the total route between starting location 3 and destination location 4 (having partial route 7b) is shorter in this example than the total route shown in FIG. 1b.

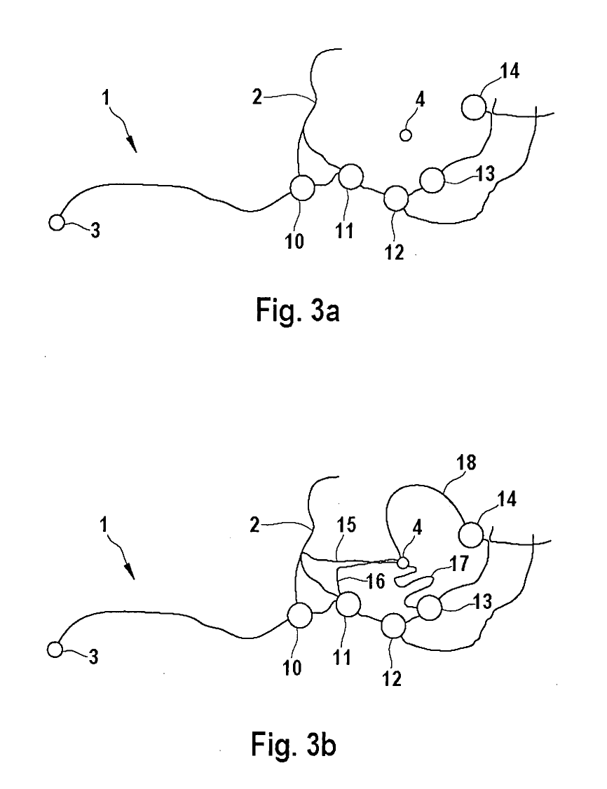

In the exemplary embodiment illustrated with reference to FIGS. 3a and 3b, the mobile navigation client selects several points 10 through 14 as a preselection from map data available to it. These points are transmitted as possible transfer points to the central route server. The central route server then calculates a partial route 15 through 18 for each transfer point 10 through 14. Furthermore, travel times and travel distances are calculated for each of partial routes 15 through 18 and this information is sent to the mobile navigation client. The mobile navigation client then calculates the total travel times and/or total travel distances for all total routes and subsequently ascertains the optimum total route.

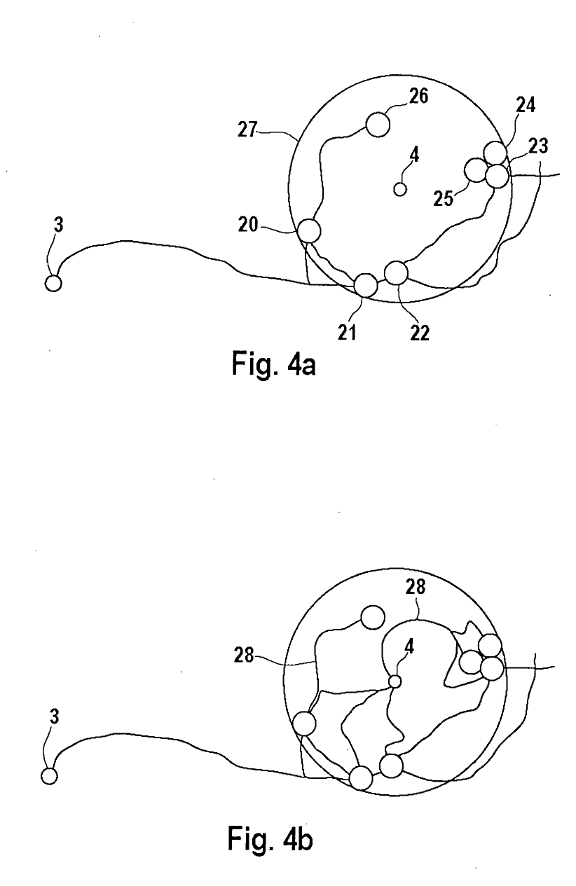

FIG. 4a shows possible transfer points 20 through 26 selected by the mobile navigation client. All selected points are within a predetermined radius 27 from destination location 4. Other conditions for selection of points 20 through 26 may include all of these possible transfer points being situated at an intersection or approximately at the center between two intersections. As already explained with reference to the example in FIGS. 3a and 3b, partial routes 28 are calculated by the central route server for all possible transfer points, as illustrated in FIG. 4b, and this information is then sent to the mobile navigation client. The latter then selects the best total route, taking into account travel times and/or travel distances of the total routes, and guides the user from starting location 3 to destination location 4 based on this selected total route.

1-8. (canceled)

9. A method for determining a total route for navigating from a starting location to a destination location, comprising:
calculating at least one first partial route of the total route locally in a mobile navigation client;
determining at least one transfer point as an end point of the at least one first partial route and as a starting point of at least one second partial route, wherein the transfer point is determined based on at least one criterion for optimizing the total route; and
calculating the at least one second partial route centrally in a stationary route server.

10. The method as recited in claim 9, further comprising:
determining that the total route to the destination location is not calculable entirely by the mobile navigation client;
transmitting the destination location from the mobile navigation client to the stationary route server;
transmitting a destination list from the stationary route server to the mobile navigation client;
confirming the destination location by the user in the mobile navigation client;
transmitting the at least one transfer point to the stationary route server, wherein the at least one second partial route from the at least one transfer point to the destination location is calculated in the stationary route server; and
transmitting the at least one second partial route to the mobile navigation client.

11. The method as recited in claim 10, wherein the at least one transfer point is a point that is: a) on a partial route calculable by the mobile navigation client; and b) at the shortest geographic distance from the destination location.

12. The method as recited in claim 10, wherein the at least one transfer point is a point that is: a) on a partial route calculable by the mobile navigation client; and b) situated between the starting location and a point on the partial route calculable by the mobile navigation client that is the shortest geographic distance from the destination location.

13. The method as recited in claim 10, further comprising:
designating multiple potential transfer points on a partial route calculable by the mobile navigation client, wherein the multiple points are situated between the starting location and a point on the partial route calculable by the mobile navigation client that is the shortest geographic distance from the destination location;
calculating multiple potential second partial routes from the multiple potential transfer points to the destination location, wherein calculation of each potential second partial route includes calculating a travel distance and a travel time of each potential second partial route; and
selecting one of the multiple potential transfer points as the at least one transfer point, wherein the selected transfer point is a point that optimizes the total route with respect to at least one of a travel distance and a travel time.

14. The method as recited in claim 10, further comprising:
designating multiple potential transfer points on a partial route calculable by the mobile navigation client, wherein the multiple points are situated between the starting location and a point on the partial route calculable by the mobile navigation client that is within a predetermined maximum distance from the destination location;
calculating multiple potential second partial routes from the multiple potential transfer points to the destination location, wherein calculation of each potential second partial route includes calculating a travel distance and a travel time of each potential second partial route; and
selecting one of the multiple potential transfer points as the at least one transfer point, wherein the selected transfer point is a point that optimizes the total route with respect to at least one of a travel distance and a travel time.

15. The method as recited in claim 11, wherein the at least one transfer point is situated at least one of at an intersection and at a turn-off.

16. The method as recited in claim 12, wherein the at least one transfer point is situated at least one of at an intersection and at a turn-off.

17. The method as recited in claim 13, wherein the designated multiple potential transfer points are each situated at least one of: a) at an intersection; b) at a turn-off; c) between two intersections; d) between two turn-offs; and e) between an intersection and a turn-off.

18. The method as recited in claim 14, wherein the designated multiple potential transfer points are each situated at least one of: a) at an intersection; b) at a turn-off; c) between two intersections; d) between two turn-offs; and e) between an intersection and a turn-off.
